(19) United States
(12) Patent Application Publication
(10) Pub. No.: US 2013/0191955 A1
(43) Pub. Date: Aug. 1, 2013

(54) METHOD AND APPARATUS FOR COMBINED ENERGY STORAGE AND BALLISTICS PROTECTION

(71) Applicant: Matthew H. Ervin, Clarksville, MD (US)

(72) Inventor: Matthew H. Ervin, Clarksville, MD (US)

(21) Appl. No.: 13/361,989

(22) Filed: Jan. 31, 2012

(51) Int. Cl. F41H 1/02; B82Y 30/00

(52) U.S. Cl. 2/2.5; 977/742; 977/773

(57) ABSTRACT

A ballistics protective wearable item comprising a ballistics protective layer comprising a ballistics protective material having fibers coated with an electrochemical capacitive layer.

### GOVERNMENT INTEREST

Governmental Interest—The invention described herein may be manufactured, used and licensed by or for the U.S. Government.

### FIELD OF INVENTION

Embodiments of the present invention generally relate to protective outerwear and energy storage and, more particularly, to a method and apparatus for combined energy storage and ballistics protection.

### BACKGROUND OF THE INVENTION

Law Enforcement officers, emergency first-responders, soldiers and other field-workers are often occupied with long tasks or missions which require extended periods of time in the field. These field-workers often have devices which need to be powered and therefore are always carrying a power-source and backups for those power sources. For a 72 hour mission, soldiers carry 20-30 lbs of batteries. A fully equipped improved outer-tactical vest weighs an additional 30-35 lbs, in addition to the batteries. Together, the vest and batteries represent a significant mass and volume burden that reduces mobility and increases fatigue. In addition, soldiers frequently replace all of their batteries at the start of a mission to make sure they have a full charge. This represents a significant logistical burden in coordination of workers, batteries, determining whether there is charge in the batteries and the like. When a dangerous situation arises, the ability of law enforcement officers and soldiers to save lives depends on the ability to provide reliable power to communication and monitoring systems to support cross-agency situation awareness and coordination activities, without unduly burdening the officers and soldiers with the excessive weight of batteries.

Therefore, there is a need in the art for a method and apparatus for providing energy storage and ballistics protection for reducing the loading weight and increasing mobility of field workers in a more efficient manner.

### BRIEF SUMMARY OF THE INVENTION

Embodiments of the present invention relate to a ballistics protective wearable item comprising a ballistics protective layer comprising a ballistics protective material having fibers coated with an electrochemical capacitive layer.

Embodiments of the present invention relate to a method for creating a ballistics protective wearable item with energy storage comprising coating fibers of a ballistics protective material with a capacitive layer forming a ballistics protective layer.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of a frontal view of a protective vest in accordance with at least one exemplary embodiment of the present invention;

FIG. 2 is an illustration of a cross-sectional side view of the protective vest in accordance with exemplary embodiments of the present invention;

FIG. 3 is an illustration of a closer view of a capacitive material as an electrochemical double layer capacitor in accordance with exemplary embodiments of the present invention;

FIG. 5a is an illustration of graphene at the atomic level in accordance with at least one embodiment of the present invention;

FIG. 5b is an illustration of carbon nano-tubes at the atomic level in accordance with exemplary embodiments of the present invention;

FIG. 6 is an illustration of aramid fabric with crimped electrical connections in accordance with one or more aspects of the present invention; and

FIG. 7 is an illustration of the graphene and/or carbon nano-tube structure coating the fiber weave over fine metal wires in accordance with one or more aspects of the present invention.

### DETAILED DESCRIPTION OF THE INVENTION

Embodiments of the present invention comprise a protective vest made of protective material where the woven fibers of the protective material are coated with graphene and/or carbon nano-tubes and placed in an electrolytic solution so as to store energy. The large surface area of graphene/carbon nano-tubes coated on the woven fibers in the protective material allows for ideally large electrolyte accessible surface areas of the Graphene/carbon nano-tubes acting as electrodes. In electrochemical capacitors, the capacitance is directly proportional to the surface area of the electrodes.

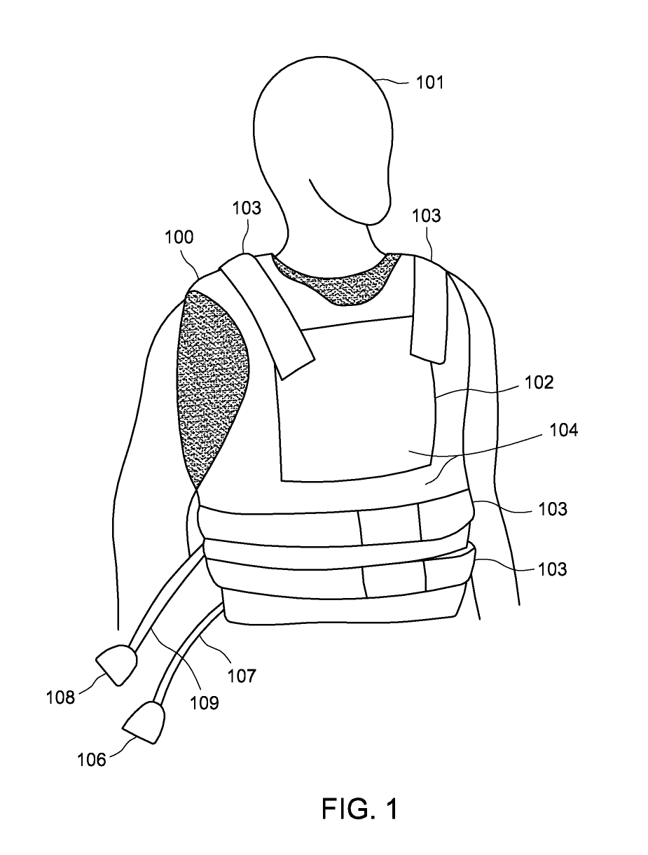

FIG. 1 is an illustration of a frontal view of a protective vest 100. In an exemplary embodiment, the vest 100 is a ballistics protective vest capable of storing energy. The vest 100 comprises a breast plate 102, latches 103, outer covering 104, charging input 106 and electrical output 108. The charging input 106 is coupled to the vest 100 by insulated cable 107. The output 108 is coupled to the vest 100 by insulated cable 109. Devices that are operable to be powered by the output 108 include radio transmitters, receivers, rescue beacons, and the like. In exemplary embodiments, any device that requires intermittent power draw that is higher than can be efficiently delivered by the soldiers portable power sources such as batteries, solar panels, fuel cells, and the like are powered by the output 108. In other exemplary embodiments any device that uses an amount of energy that can be supplied on a single charge may be powered by the output 108 without the use of an auxiliary portable power source. Devices that are operable to be coupled to the charging input 106 include batteries, solar panels, fuel cells, direct power and the like.

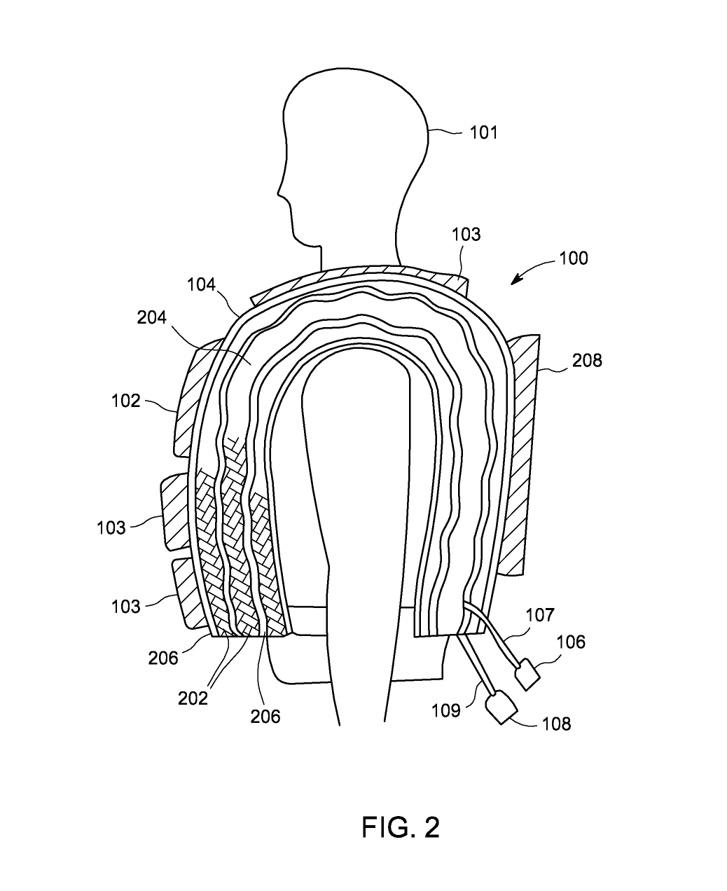

FIG. 2 is an illustration of a cross-sectional side view of the protective vest 100. The wearer 101 of the vest 100 straps on the vest using straps 103. The outer covering 104 is comprised of textiles for abrasion resistance, camouflage patterns, and attachment points for other equipment. The internal capacitive cells are comprised of a ballistic grade fiber weave 202 coated with the capacitive material 206. In an exemplary embodiment, the fiber weave 202 is a para-aramid synthetic fiber weave, such as Kevlar®. The fiber weave 202 coated with the capacitive material 206 sits in an electrolytic solution 204. The input and output 106 and 108 are coupled to the capacitive material 206 by cables 107 and 109. The input 106 allows the capacitive material to be charged and the output 108 allows for an electrical device to be powered by the energy stored in the capacitive material 206. In an exemplary embodiment, the vest 100 also comprises a protective back pad 208 also comprised of a fiber-weave 202 of para-aramid synthetic fiber. In other embodiments, the vest 100 has small portions which provide for energy storage such as protective back bad 208. In other embodiments of the present invention, the ballistics protection and energy storage is located in different gear such as helmets, boots, and other garments.

According to an exemplary embodiment, the capacitive material 206 forms an electrochemical double layer capacitor (EDLC) with the fiber weave 202 and the electrolyte 204. The energy density of an EDLC is typically over one hundred times greater than electrolytic capacitors. The EDLC also has significantly higher power density than batteries and fuel cells. EDLCs, unlike dielectric or electrolytic capacitors, do not have a dielectric layer on the capacitor electrodes. Since capacitance goes down with an increase in the separation distance between the separated charges (the dielectric thickness in a conventional capacitor, or the electrolyte ions and the electrodes in an EDLC), eliminating the dielectric greatly increases the capacitance. In exemplary embodiments, an EDLC is two capacitors in series with each electrode and its associated electrolyte double layer comprising a capacitor. Each electrode, when charged, forms a double layer of separated electrolyte ions next to the electrode. For example, the positive electrode attracts (adsorbs) negative ions (anions) to its surface and repels positive ions (cations) forming a double layer of separated charge in the electrolyte. Likewise, the negative electrode forms a similar double layer. Since there is no dielectric between the electrode and the adsorbed ions, the separation between the charges in the electrode and the electrolyte are on the order of atomic distances resulting in very large capacitances. The lack of a bulky layer of dielectric, and the porosity of the material used, permits the packing of very large surface areas into a given volume, resulting in high capacitances in practical-sized packages.

The electrolyte solution 204 is an ionically conductive solution with electrolyte ions passing back and forth between a first electrode and second electrode during charging and discharging. In an exemplary embodiment, an aqueous sodium chloride/polyvinyl alcohol (PVA) gel electrolyte is used. The PVA is nontoxic and presents no hazards to the wearer of vest 100 if the vest is ruptured. The salt concentration and the salt/PVA ratio is adjustable to achieve better electrical and mechanical performance. In another embodiment, water or ionic liquid based electrolyte liquids or gels are used as the electrolyte solution 204. In other exemplary embodiments of the invention, the electrolyte solution is composed of solid conductive polymer electrolytes, such as Nafion®, polyaniline, and the like. Optionally, the electrolyte solution 204 is enhanced with polymers having better ballistics protection properties. In yet another embodiment, nano-particles are used to increase friction and sheer thickening behavior of a gel electrolyte to reduce the possibility of projectile penetration through the vest due to a lubrication effect.

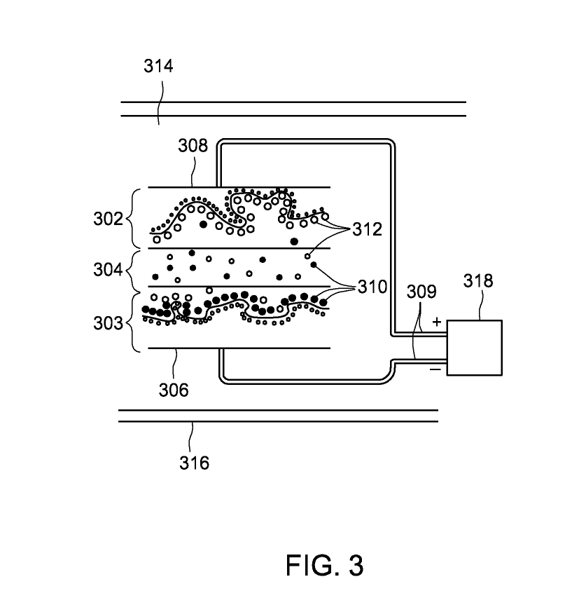

FIG. 3 is an illustration of a closer view of the capacitive material 206 as an EDLC. There is a first and second electrode 302 and 303, both with conductive high surface areas, for collecting charge. The electrodes consist of a Kevlar® material mechanical support, a highly conductive current collector layer 306 and 308 which in exemplary embodiments are separate from or integrated into the high surface area active layer. The current collector may comprise a conductive metallic, polymer, or carbon nano-tube coating on the Kevlar fibers. The high surface area active layer that is responsible for storing the charge is comprised of graphene and/or carbon nano-tubes coating the Kevlar fibers/current collector. It is possible that the active layer, if conductive enough, may also function as the current collector. A porous membrane separates the first electrode 302 and the second electrode 303 and is typically referred to as the separator 304. In one embodiment, the separator 304 function is performed by a porous membrane. In another embodiment, the polymer in a gel or solid electrolyte may function as the separator 304 to separate the electrodes and keep them from electrically shorting. The first and second electrodes 302 and 303, along with the separator 304, are suspended in an electrolyte solution 314, enclosed in a hermetic package 316. The separator 304 protects the first and second electrode from discharging by coming into contact with each other and allows for electrolyte ions to travel between the first electrode 302 and second electrode 303. When a voltage is applied across the electrodes, ions in the electrolyte 314 separate with positive ions 310 going to the negatively biased electrode and negative ions 312 going to the positively biased electrode. A subsequent electrical load applied across the electrodes 302 and 303 causes the capacitive material 206 to discharge stored energy across the load as the electrolyte ions redistribute in the cell. The first and second electrode 302 and 303 are connected as a power source or as an energy storage capacitor to output 309, which delivers power to an external device 318.

In the case of EDLCs, the distance between the conductive electrode and the electrostatically absorbed ions is inversely proportional to the capacitance. The lack of a dielectric in capacitive material 206 reduces the voltage that the EDLC can be charged to, as aqueous electrolytes will start to decompose above about one volt and ionic liquid electrolytes decompose at 3.5V or more. In turn, electrochemical capacitors can charge and discharge rapidly. In an exemplary embodiment, pseudocapacitance is included in the EDLC consisting of fast surface reduction or oxidation (redox) reactions chemically similar to those in a battery, behaving electrically like a capacitance. Such capacitance may be included by incorporating conductive polymers or transition metal oxides in the electrodes. Optionally, a battery or fuel cell's high energy density is used to supply intermittent high power needs by delivering power at continuous lower rate to the capacitive material 206, which then supplies burst power to external devices 318. As a result, there will be an increase in energy that the battery supplies by reducing power dissipation via Joule heating. In an exemplary embodiment of the present invention, covalent bonding of the graphene and/or carbon nano-tubes to the electrodes 302 and 303 is performed to add durability to the capacitive material 206.

For example it is known to those of ordinary skill in the art that a battery can deliver more energy at lower discharge rates. For instance an Energizer® Alkaline E91 double A battery can deliver 1 Watt Hour (Wh) of energy at a discharge rate of 1W (Watt), but the same double A battery can deliver 3 Wh at 0.1 W. Finally, other benefits of using EDLCs is that they also discharge in seconds, have long lifetimes (10^{̂5}-10̂6 cycle), can be made with non-hazardous material, perform well at temperature extremes, and have a high efficiency (98%).

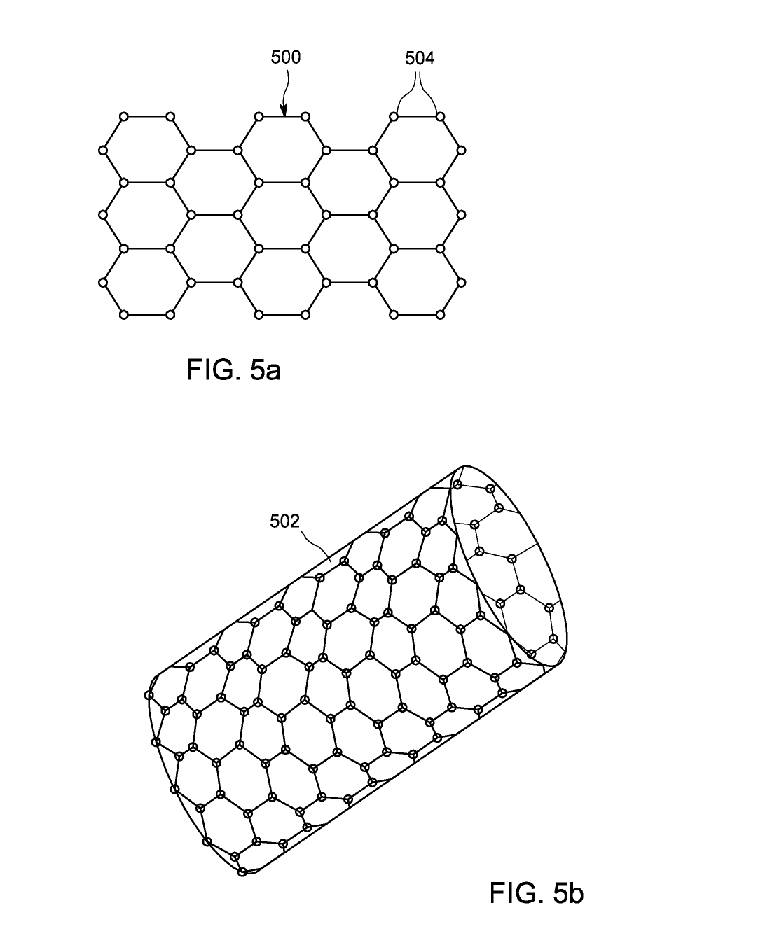

FIG. 5a is an illustration of Graphene at the atomic level. In an exemplary embodiment, Graphene is used as a conductive, high surface area electrode material such as the first and second electrode 302 and 303 in FIG. 3. Graphene is an allotrope of carbon, whose structure is one-atom-thick planar sheets of sp2-bonded carbon atoms 504 that are densely packed in a honeycomb crystal lattice 500. The carbon nano-tube structure 502 shown in FIG. 5b, is formed when the graphene structure 500 is curved back onto itself to form a cylinder. The one layer thick cylinder 502 is a single wall carbon nano-tube. In other exemplary embodiments of the present invention, the cylinder 502 is a multiwall carbon nano-tube comprising concentric cylinders of structure 502. In an exemplary embodiment, capacitance of a single-layer graphene material is approximately 120 Farads per gram (though the present invention does not limit the capacitance in this regard) and it is coated onto the Kevlar fibers as small sheets (which are, in exemplary embodiments, approximately 1 micron across) by dip coating the Kevlar in a graphene oxide in water solution followed by thermal, chemical or electrochemical reduction of the graphene oxide to graphene. In another embodiment, carbon nano-tubes are solution coated onto the Kevlar fibers with or without graphene (oxide).

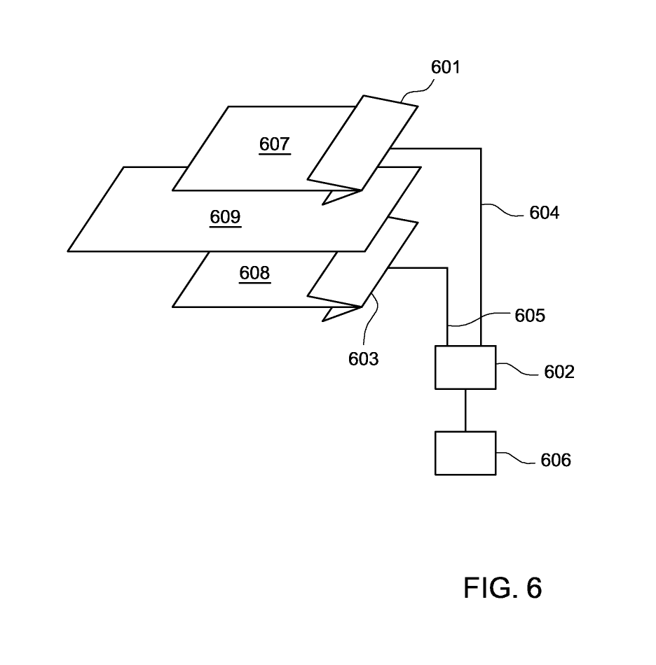

FIG. 6 is an illustration of aramid fabric 607 and 608 with crimped electrical connections. The aramid fabric 607 and 608 each respectively form the electrodes 302 and 303. The fabric 607 and 608 are coated with the graphene sheets discussed above and store and discharge energy from/to the interface 602 through electrical connections 604 and 605 which are connected to a metal crimping mechanism 601 and 603 for crimping to the Kevlar® fabric. In this embodiment, one Kevlar® based electrode is crimped to the positive lead 601 and the adjacent Kevlar® based electrode is crimped to the negative lead 603. To prevent shorting, there is a separator material 609 between the two adjacent Kevlar® electrodes. In one embodiment, the Kevlar® fiber is approximately 15 microns in diameter. In another exemplary embodiment, device 606 is a battery or solar panel to allow the capacitor formed by graphene and/or carbon nano-tube 502 and fiber weave 202 to store energy. In another embodiment, the device 606 is a device such as a radio which uses the energy discharged from the capacitor formed by graphene and/or carbon nano-tube 502 and fiber weave 202 to operate.

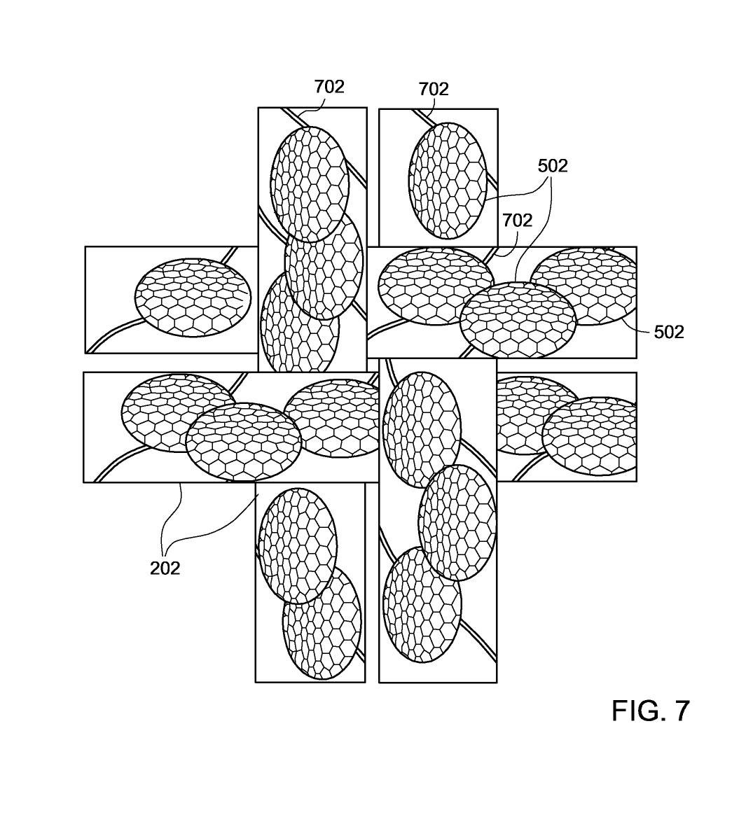

FIG. 7 is an illustration of the graphene and/or carbon nano-tube structure 502 coating the fiber weave 202 over fine metal wires for resistance reduction, in a similar fashion to FIG. 6. Small sheets of graphene or carbon nano-tubes 502 overlap with each other and the Kevlar® fiber shown is coated with multiple layers of the sheets or tubes 502, though not shown. Fine metal wires 702 are woven with the Kevlar® fibers along the length of the entire fabric, such that the wires 702 and the Kevlar® fibers form a Kevlar® yam. This reduces the resistance of the electrodes formed by the Kevlar® fiber and the nano-tube 502 since conduction through the graphene/CNTs would not have to go far before conduction switches to the more conductive metal wires 702.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

Various elements, devices, modules and circuits are described above in associated with their respective functions. These elements, devices, modules and circuits are considered means for performing their respective functions as described herein. While the foregoing is directed to embodiments of the present invention, other and further embodiments of the invention may be devised without departing from the basic scope thereof, and the scope thereof is determined by the claims that follow.

1. A ballistics protective wearable item comprising:
a ballistics protective layer comprising a ballistics protective material having fibers coated with an electrochemical capacitive layer.

2. The wearable item of claim 1 further comprising one or more energy interfaces coupled to the capacitive layer for receiving energy for storage and for coupling to devices requiring energy from the storage.

3. The wearable item of claim 2 wherein the ballistics protective material is an aramid fabric.

4. The wearable item of claim 2 wherein the capacitive layer further comprises:
an electrolytic solution having a first and second electrode having high surface areas;
an electrode separator for preventing the first and second electrode from contacting each other and discharging capacitance; and
packaging for sealing the electrolytic solution, the separator, and the first and second electrode.

5. The wearable item of claim 4 wherein the electrolytic solution is one of an aqueous sodium chloride polyvinyl alcohol gel solution, solid polymer electrolytes, polymer and liquid electrolytes, gel electrolytes, ionic liquid electrolytes, organic electrolytes, or salt water.

6. The wearable item of claim 4 wherein the first and second electrodes are comprised of graphene or carbon nano-tubes (CNT), or graphene and CNTs coupled with the ballistics protective material.

7. The wearable item of claim 5 wherein the at least one of the electrolytic solution or the first and/or second electrode are coupled with nano-particles to increase one or more of stopping power of the ballistics protective layer or energy storage of the wearable item.

8. The wearable item of claim 4 wherein the separator is at least one of a porous membrane, a polymer gel electrolyte, or a solid polymer electrolyte which allow electrolyte ions or protons to flow between the first and second electrode.

9. A method for creating a ballistics protective wearable item with energy storage comprising:
coating fibers of a ballistics protective material with a capacitive layer forming a ballistics protective layer.

10. The method of claim 9 further comprising one or more energy interfaces coupled to the capacitive layer for receiving energy for storage and for coupling to devices requiring energy from the storage.

11. The method of claim 10 wherein the ballistics protective material is an aramid fabric.

12. The method of claim 10 wherein the capacitive layer further comprises:
an electrolytic solution having a first and second electrode having high surface areas;
an electrode separator for preventing the first and second electrode from contacting each other and discharging capacitance; and
packaging for sealing the electrolytic solution, the separator, and the first and second electrode.

13. The method of claim 12 wherein the electrolytic solution is one of an aqueous sodium chloride polyvinyl alcohol gel solution, solid polymer electrolytes, polymer and liquid electrolytes, gel electrolytes, ionic liquid electrolytes, or salt water.

14. The method of claim 12 wherein the first and second electrodes are comprised of Graphene or carbon nano-tubes (CNT), or graphene and CNTs coupled with the ballistics protective material.

15. The method of claim 13 wherein the at least one of the electrolytic solution or the first and/or second electrode are coupled with nano-particles to increase one or more of stopping power of the ballistics protective layer or energy storage of the wearable item.

16. The method of claim 4 wherein the separator is at least one of a porous membrane, a polymer gel electrolyte, or a solid polymer electrolyte which allow electrolyte ions or protons to flow between the first and second electrode.

17. The wearable item of claim 1 wherein the ballistics protective layer further comprises conductive wires below the electrochemical capacitive layer woven with the fibers.

18. The wearable item of claim 1 wherein the a first and second fiber of the fibers form, respectively, a positive and negative electrode by having a first and second conductive crimp crimped to the ends of the first and second fibers.

19. The wearable item of claim 18 wherein the first and second fibers are separated by a non-conductive material.

20. The method of claim 9 further comprising overlapping one or more capacitive layers and crimping a first and second conductive crimp to ends of a first and second fiber from the fibers.
